(19) United States
(12) Patent Application Publication
(10) Pub. No.: US 2004/0251738 A1
(43) Pub. Date: Dec. 16, 2004

(54) Magnet valve with reduced swiching noise

(76) Inventors: Dieter Kawa, Erdmannhausen (DE); Guenther Schnalzger, Blaichach (DE); Andreas Reize, Stuttgart (DE); Klaus-Dieter Fietz, Oberriexingen (DE); Christian Laier, Neckarhousen (DE); Oliver Holz, Altenriet (DE)

Correspondence Address: RONALD E. GREIGG, GREIGG & GREIGG P.L.L.C., Suite One, 1423 Powhatan Street, Alexandria, VA, 22314, US

(21) Appl. No.: 10/859,959

(22) Filed: Jun. 4, 2004

(30) Foreign Application Priority Data
Jun. 5, 2003 (DE) 1 03 25 442.0

(51) Int. Cl. B60T 8/36

(52) U.S. Cl. 303/119.2

(57) ABSTRACT

A magnet valve, including a pole core, an armature, a restoring element disposed between the pole core and the armature to restore the armature to its outset position a stop face on the pole core oriented toward the armature having at least one rib extending all the way around in the circumferential direction and protruding toward the armature, and/or a stop face of the armature oriented toward the pole core and having at least one rib extending all the way around in the circumferential direction and protruding toward the pole core.

### BACKGROUND OF THE INVENTION

1. Field of the Invention

The present invention relates to an improved magnet valve of the type including a pole core, an armature, and a restoring element disposed between the pole core and armature for restoring the armature to its outset position.

2. Background of the Invention

One magnet valve of the type with which this invention is concerned is known from German Patent Disclosure DE 198 02 464 A1 in which a pole core, a magnet armature guided longitudinally movably in a valve housing, and a restoring spring disposed between the magnet armature and the pole core are provided. In the currentless state, the magnet valve is closed. Upon opening of the magnet valve, the magnet armature is moved counter to the spring force and strikes the pole core. This impact of the armature on the pole core causes a very readily audible, metallic-sounding switching noise. The stop faces of the pole core and of the armature are embodied as flat faces, so that a fluid present between the pole core and the armature in the currentless state flows unhindered radially outward upon switching of the magnet valve. Also in the known magnet valve, magnetic adhesion of the armature to the pole core can occur, so that imprecisions are possible in terms of the instant of the closing event.

### OBJECT AND SUMMARY OF THE INVENTION

The magnet valve of the present invention has the advantage over the prior art that upon switching of the magnet valve, switching noise is virtually no longer perceptible. Moreover, a magnetic adhesion of the armature to the pole core is prevented according to the invention, so that the magnet valve can maintain the required switching instants very well and precisely. These advantages are attained according to the invention by providing that a closed, axially protruding rib extending in the circumferential direction is embodied on the stop face of the pole core and/or on the stop face of the armature. Because of this encompassing rib on the pole core and/or on the armature, a gap that becomes smaller and smaller occurs between the pole core and the armature upon switching of the magnet valve. Fluid present between the pole core and the armature is forced through this slight gap upon switching, so that a gap flow via the protruding rib occurs, thereby damping the impact of the armature on the pole core. The switching noise that occurs is damped as a result. The protruding rib, which according to the invention extends all the way around, thus prevents an unhindered radial outflow of the fluid, so that the fluid present between the pole core and the armature can be used as a damping medium.

To make it especially simple and economical to produce, the stop face of the armature and/or the stop face of the pole core each have precisely one protruding rib extending all the way around in the circumferential direction. To form the protruding rib on the stop face of the armature and/or the stop face of the pole core, a substantially cylindrical recess is especially preferably provided. This recess preferably has a larger diameter than a restoring element disposed between the armature and the pole core.

To furnish especially good damping and thus low switching noise, a plurality of protruding cylindrical-annular ribs are embodied on the stop face of the pole core and/or on the stop face of the armature.

Especially preferably, at least two cylindrical-annular ribs are joined together by radial ribs. As a result of this embodiment, depending on the number of radial ribs, many recesses, each filled with fluid, are formed between the cylindrical-annular ribs and the radial ribs. The result between the armature and the pole core is many regions functioning like fluid cushions, so that an especially good damping action can be obtained because of many gap flows. Especially preferably, the recesses between the cylindrical-annular ribs and the radial ribs are embodied essentially trapezoidally.

As the restoring element between the armature and the pole core, a cylindrical helical spring is preferably provided. This also has the advantage that fluid can also flow through the windings of the helical spring, as long as the helical spring is not compressed completely, and thus an additional damping effect can be obtained.

To make them especially simple and economical to produce, the protruding ribs on the stop face of the pole core and/or on the stop face of the armature are produced by means of cold forming, in particular cold pressing.

The magnet valve of the invention is used especially preferably in an anti-lock system (ABS), a vehicle stability system, such as ESP, or a brake system, in particular an electrohydraulic brake system.

### BRIEF DESCRIPTION OF THE DRAWINGS

The invention will be better understood and further objects and advantages thereof will become more apparent from the ensuing detailed description of preferred embodiments taken in conjunction with the drawings, in which:

FIG. 1 is a schematic sectional view through a magnet valve, in a first exemplary embodiment of the present invention;

FIG. 2 is an enlarged fragmentary view of the magnet valve shown in FIG. 1;

FIG. 3 is an enlarged fragmentary view of a magnet valve in a second exemplary embodiment of the present invention;

FIG. 4 is a plan view of a stop face of the invention in a third exemplary embodiment of the present invention;

FIG. 5 is a sectional view taken along the line A-A of FIG. 4;

FIG. 6 is a plan view of a stop face in a fourth exemplary embodiment of the present invention; and

FIG. 7 is a sectional view taken along the line B-B of FIG. 6.

### DESCRIPTION OF THE PREFERRED EMBODIMENTS

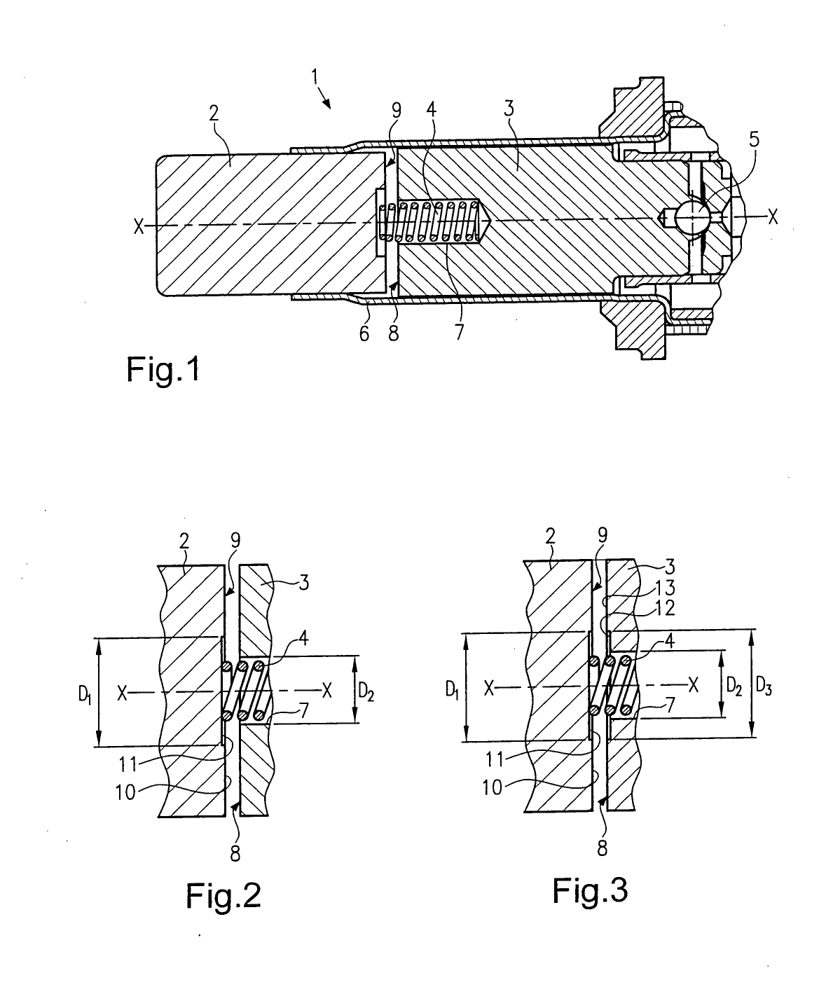

Below, referring to FIGS. 1 and 2, a magnet valve 1 in a first exemplary embodiment of the present invention includes a pole core 2, an armature 3, and a spring element 4 disposed between the pole core 2 and the armature 3. The spring element 4 is supported in a bore 7 embodied in the armature 3. The armature 3 is disposed movably in the longitudinal axis X-X in a housing 6. On the opposite end of the armature 3 from the pole core 2, a closing body 5 is disposed, to open and close an opening. The actuation of the armature 3 is done in the known manner via an electrical coil, not shown. In the currentless state, the magnet valve 1 is closed. This state is shown in FIG. 1. On the side toward the armature 3, the pole core 2 has a stop face 9, and the armature 3, on its side toward the pole core 2, has a stop face 8. In the unactuated state, a fluid is located between the two stop faces 8 and 9. Upon actuation of the magnet valve 1, this fluid present between the stop faces 8 and 9 is positively displaced radially outward.

As shown in FIG. 2, a cylindrical recess 11 is formed on the stop face 9 of the pole core 2. The spring element 4, which is embodied as a cylindrical spiral spring, touches the bottom of the recess 11. As shown in FIG. 2, the recess 11 has a diameter D₁ which is greater than an outer diameter D₂ of the spring element 4. More precisely, the diameter D₁ of the recess 11 is approximately 50% greater than the outer diameter D₂ of the spring element 4.

When the magnet valve 1 is now opened, the armature 3 moves parallel to the center axis X-X toward the pole core 2, counter to the spring force of the spring element 4. The fluid present between the pole core 2 and the armature 3 is positively displaced radially outward in the process. Since as a result of the embodiment of the recess 11, a protruding rib 10 extending all the way around in the circumferential direction is embodied on the pole core 2, the result between the protruding rib 10 and the armature 3 is a gap flow at the gap which as a result of the motion of the armature 3 is constantly decreasing in size. This gap flow between the armature 3 and the pole core 2 furnishes a hydraulic damping action, so that an impact of the armature 3 on the pole core 2 can be damped. As a result, compared to the prior art, markedly less switching noise from the impact of the armature 3 on the pole core 2 is created. Moreover, because of the recess 11 in the pole core 2, the contact area between the pole core 2 and the armature 3, which area in this exemplary embodiment is embodied annularly, is reduced compared to the prior art, so that a magnetic adhesion of the armature 3 to the pole core 2 after the magnet has been made currentless can be reduced. More-precise switching times can be maintained as a result.

The fluid which is located in the recess 11 between the pole core 2 and the armature 3 thus acts like a damping cushion upon switching of the magnet valve, so that because of how the circumferentially encompassing, protruding rib 10 is embodied, hydraulic damping is achieved. The pole core 2 can be produced as an economical part made by cold pressing, and the recess 11 and hence the protruding rib 10 can be produced simply and economically.

Turning to FIG. 3, a magnet valve in a second exemplary embodiment of the present invention will now be described. Elements that are the same or functionally the same are identified by the same reference numerals as in the first exemplary embodiment.

As in the first exemplary embodiment, both a middle recess 11 and a protruding, annularly encompassing rib 10 are embodied on the stop face 9 of the pole core. Unlike the first exemplary embodiment, on the armature 3 of the second exemplary embodiment, both a recess 12 and an annularly encompassing, protruding rib 13 are embodied on the stop face 8 of the armature 3. Thus both the pole core 2 and the armature 3 have a respective recess 11 and 12 and a protruding annular rib 10 and 13. As can be seen from FIG. 3, the recess 11 has a diameter D₁ which is equivalent to the diameter D₃ of the recess 13 on the armature. It should be noted that the diameters of the recesses 11 and 12 need not be the same; instead, they can be selected to be different.

Upon motion of the armature 3 in the direction of the pole core 2, as the gap becomes increasingly smaller, a gap flow between pole core 2 and the armature 3 is created, which damps an impact of the armature 3 on the pole core 2. As a result, the switching noise of the magnet valve 1 can be reduced. Otherwise, this exemplary embodiment is equivalent to the first exemplary embodiment, so that reference may be made to the description of the latter above.

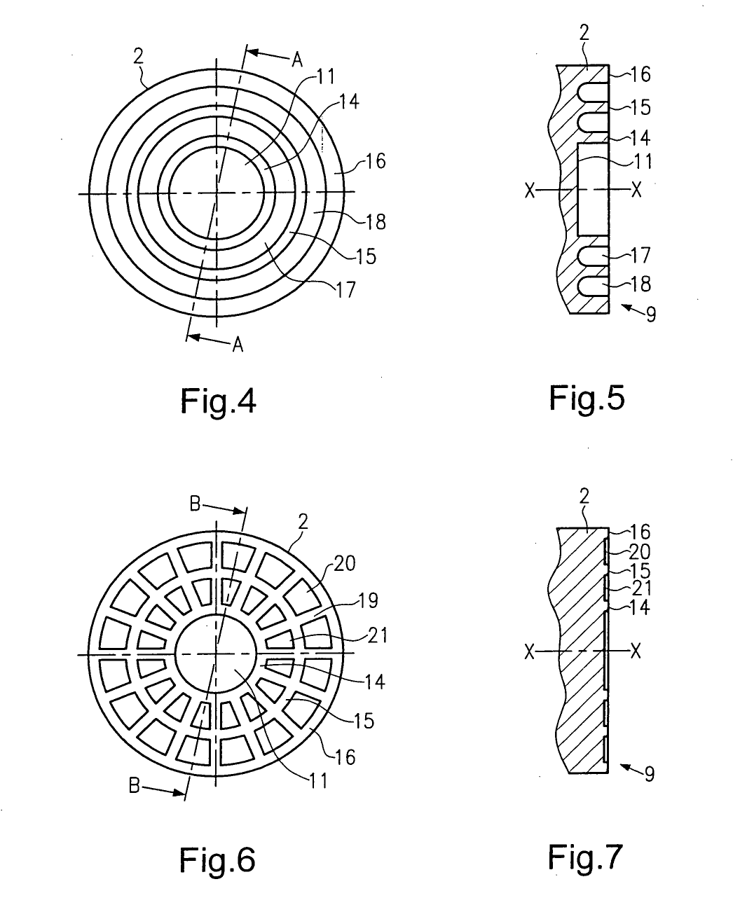

Turning to FIGS. 4 and 5, a third exemplary embodiment of the invention will now be described. Once again, elements that are the same or functionally the same are identified by the same reference numerals as in the above exemplary embodiments.

As shown in FIGS. 4 and 5, the pole core 2 of the third exemplary embodiment has a plurality of annularly encompassing, protruding ribs as well as a plurality of recesses. More precisely, the pole core 2 in the third exemplary embodiment has three protruding ribs 14, 15, 16, and three recesses 11, 17 and 18. Both the recesses 11, 17 and 18 and the ribs 14, 15 and 16 are disposed concentrically to the center axis X-X of the magnet valve. As a result of this embodiment of the pole core 2, at the regions between the ribs 14, 15 and 16 as well as the stop face of the armature (not shown), gap flows develop in each case, so that even further-improved damping than in the first two exemplary embodiments can be obtained. Moreover, the contact area between the pole core 2 and the armature 3 is reduced, so that lesser magnetic adhesion forces are present, making it easier to release the armature from the pole core. The width of each of the ribs 14, 15, 16 and recesses 17, 18 and the diameter of the middle recess 11 can be selected arbitrarily. Otherwise, this exemplary embodiment is equivalent to the exemplary embodiments above, so that their description may be referred to for it.

It should also be noted that it is understood that the armature may be embodied as shown in the plan view of FIG. 4, and a bore for receiving the spring element is additionally embodied in the recess 11. It should also be noted that the number of protruding ribs and recesses can likewise be varied.

Turning to FIGS. 6 and 7, a fourth exemplary embodiment of the present invention will be described. Once again, identical elements are identified by the same reference numerals as in the first several exemplary embodiments.

The fourth exemplary embodiment is essentially equivalent to the third exemplary embodiment, but in addition to the protruding annular ribs 14, 15, 16, a plurality of radial ribs 19, specifically eight of them, are embodied. The radial ribs 19 each extend from the innermost annular rib 14 to the outermost annular rib 16 (see FIG. 6). As a result, between the radial ribs 19 and the three annular ribs 14, 15, 16, essentially trapezoidal indentations or recesses 20, 21 are each created, which are disposed at equal spacings from one another in the circumferential direction. Since the width of the radial ribs 19 remains constant, the recesses 21 located farther inward are smaller than the recesses 20 located farther outward. Thus a plurality of cushionlike damping regions are formed on the stop face of the pole core, and the fluid located between the pole core 2 and the armature 3 is positively displaced, upon actuation of the magnet valve, both via the annular ribs 14, 15, 16 and the radial ribs 19, creating a gap flow for damping the impact of the armature on the pole core. Once again, the embodiment of the stop face of the pole core described above can be produced by means of cold pressing.

It should also be noted that the embodiment of the stop face shown in FIG. 6 can also be employed for the armature; for the armature, a bore for receiving the spring element would additionally have to be provided in the middle recess 11.

It should also be noted that the various embodiments of the stop faces of the present invention can be provided arbitrarily for the armature 3 and the pole core 2; in particular, arbitrary combinations of different patterns on the pole core 2 and on the armature 3 may be provided. For instance, the stop face of the pole core shown in FIGS. 4 and 5 can be combined with a stop face of the armature of the kind shown in FIG. 3, or a stop face of the armature of the kind embodied in accordance with FIG. 6. In other words, there are no restrictions whatever in terms of the possible combinations of differently embodied stop faces on the pole core and on the armature. It is understood that the stop faces may also be embodied identically on the pole core and on the armature.

The foregoing relates to preferred exemplary embodiments of the invention, it being understood that other variants and embodiments thereof are possible within the spirit and scope of the invention, the latter being defined by the appended claims.

We claim:

1. A magnet valve, comprising
a pole core (2),
an armature (3),
a restoring element (4) disposed between the pole core (2) and the armature (3) for restoring the armature (3) into its outset position, and
a stop face (9) on the pole core (2) oriented toward the armature (3), the stop face (9) having at least one rib (10; 14, 15, 16), extending all the way around in the circumferential direction and protruding toward the armature, and/or a stop face (8), on the armature (3) and oriented toward the pole core (2), and having at least one rib (13) extending all the way around in the circumferential direction and protruding toward the pole core.

2. The magnet valve in accordance with claim 1, wherein the stop face (8) of the armature (3) and/or the stop face (9) of the pole core (2) has precisely one protruding rib extending all the way around in the circumferential direction.

3. The magnet valve in accordance with claim 1, further comprising a cylindrical recess (11) embodied concentrically to a longitudinal axis (X-X) of the magnet valve in the middle of the stop face (8) of the armature (3) and/or a cylindrical recess (12) in the middle of the stop face (9) of the pole core (2).

4. The magnet valve in accordance with claim 2, further comprising a cylindrical recess (11) embodied concentrically to a longitudinal axis (X-X) of the magnet valve in the middle of the stop face (8) of the armature (3) and/or a cylindrical recess (12) in the middle of the stop face (9) of the,pole core (2).

5. The magnet valve in accordance with claim 1, wherein the cylindrical recess (11, 12) has a diameter (D₁, D₃) which is greater than a diameter (D₂) of the restoring element (4).

6. The magnet valve in accordance with claim 1, wherein the stop face (8) of the armature (3) and/or the stop face (9) of the pole core (2) comprises a plurality of protruding cylindrical-annular ribs (14, 15, 16).

7. The magnet valve in accordance with claim 2, wherein the stop face (8) of the armature (3) and/or the stop face (9) of the pole core (2) comprises a plurality of protruding cylindrical-annular ribs (14, 15, 16).

8. The magnet valve in accordance with claim 3, wherein the stop face (8) of the armature (3) and/or the stop face (9) of the pole core (2) comprises a plurality of protruding cylindrical-annular ribs (14, 15, 16).

9. The magnet valve in accordance with claim 5, wherein the stop face (8) of the armature (3) and/or the stop face (9) of the pole core (2) comprises a plurality of protruding cylindrical-annular ribs (14, 15, 16).

10. The magnet valve in accordance with claim 6, wherein the protruding cylindrical-annular ribs (14, 15, 16) are joined together by radial ribs (19).

11. The magnet valve in accordance with claim 10, wherein essentially trapezoidal recesses (20, 21) are embodied between the protruding cylindrical-annular ribs (14, 15, 16) and the radial ribs (19).

12. The magnet valve in accordance with claim 2, wherein essentially trapezoidal recesses (20, 21) are embodied between the protruding cylindrical-annular ribs (14, 15, 16) and the radial ribs (19).

13. The magnet valve in accordance with claim 3, wherein essentially trapezoidal recesses (20, 21) are embodied between the protruding cylindrical-annular ribs (14, 15, 16) and the radial ribs (19).

14. The magnet valve in accordance with claim 5, wherein essentially trapezoidal recesses (20, 21) are embodied between the protruding cylindrical-annular ribs (14, 15, 16) and the radial ribs (19).

15. The magnet valve in accordance with claim 1, wherein the restoring element (4) is embodied as a cylindrical helical spring.

16. The magnet valve in accordance with claim 3, wherein the restoring element (4) is embodied as a cylindrical helical spring.

17. The magnet valve in accordance with claim 5, wherein the restoring element (4) is embodied as a cylindrical helical spring.

18. The magnet valve in accordance with claim 1, wherein the protruding ribs (10; 13; 14, 15, 16) and the recesses (11; 12; 17, 18; 20, 21) on the stop face (8) of the armature (3) and/or on the stop face (9) of the pole core (2) are produced by means of cold forming, in particular cold pressing.

19. The magnet valve in accordance with claim 6, wherein the protruding ribs (10; 13; 14, 15, 16) and the recesses (11; 12; 17, 18; 20, 21) on the stop face (8) of the armature (3) and/or on the stop face (9) of the pole core (2) are produced by means of cold forming, in particular cold pressing.

20. The magnet valve in accordance with claim 1, wherein the magnet valve is used in an anti-lock system, a vehicle stability system, and/or a brake system.
